(19) United States
(12) Patent Application Publication
(10) Pub. No.: US 2002/0086648 A1
(43) Pub. Date: Jul. 4, 2002

(54) Method and system for optimization of switched-diversity performance

(76) Inventors: Leif Wilhelmsson, Dalby (SE); Anders Wallen, Eslov (SE)

Correspondence Address: JENKENS & GILCHRIST, 3200 Fountain Place, 1445 Ross Avenue, Dallas, TX, 75202-2799, US

(21) Appl. No.: 09/894,052

(22) Filed: Jun. 28, 2001

Related U.S. Application Data
(60) Provisional application No. 60/249,706, filed on Nov. 17, 2000.

(51) Int. Cl. H04B 1/02

(52) U.S. Cl. 455/101; 455/272

(57) ABSTRACT

A change in a time derivative of a branch's received power is determined. In response to the absolute value of the received power exceeding a predetermined threshold, a second branch is switched to. The determination of the rate of change of the received power can include use of a received-signal-strength indicator. The threshold can be a function of modulation and coding. A rapid change in the time derivative of the received power indicates that the branch will soon become frequency selective and that, therefore, the second branch should be switched to in order to avoid the negative affects of the frequency selectivity of the first branch.

### CROSS-REFERENCE TO RELATED APPLICATIONS

This Patent Application claims priority from U.S. Provisional Patent Application No. 60/249,706, filed on Nov. 17, 2000 and bearing Attorney Docket No. 34650-00675USPL. This Patent Application incorporates U.S. Provisional Patent Application No. 60/249,706 by reference.

This patent application is related by subject matter to a U.S. Patent Application entitled “Method and System for Dynamic Carrier Selection” and bearing Attorney Docket No. 34650-00670USPT, which is being filed on the same date as this patent application and is incorporated by reference.

### TECHNICAL FIELD

This invention relates generally to communications in which switched diversity is employed, and, more particularly, to use of switched diversity to ameliorate performance degradation due to fading dips.

### BACKGROUND OF THE INVENTION

Switched diversity is a term that is used to refer to systems in which signals can be received on a plurality of diversity branches and, in response to performance on a currently-used diversity branch becoming insufficient, a switch to a different diversity branch occurs. The plurality of diversity branches could be, for example, antennas, such that a switch between diversity branches would entail a switch between the antennas. The plurality of diversity branches could also be, for example, carriers, such that a switch between diversity branches would entail a switch between the carriers. The term “branches” as used herein is intended to be a general term that encompasses both carriers and antennas, which are examples of diversity branches.

In wireless communication systems, data to be communicated is typically transmitted in bursts on a carrier whose characteristics vary over time. In other words, a first burst of data might be transmitted on the carrier while the carrier has very good performance that allows the first burst of data to be received correctly, while, as a second burst of data is transmitted on the carrier, the performance of the carrier might have worsened such that the second burst of data is not received correctly. This problem can be explained by the fact that carriers include multiple paths; therefore, even a small movement by either a transmitter or a receiver can affect whether these multiple paths add constructively or destructively.

If a rate of change of the performance of a carrier is relatively great in comparison to a data rate on the carrier, the problem of varying carrier performance can be solved using coding and interleaving, in which carrier performance variations are averaged so that the carrier's performance depends on average carrier conditions rather than on worst-case carrier conditions. However, if the carrier's performance varies relatively slowly and/or if the data rate is relatively great, this approach is not feasible because the number of symbols needed in the interleaver is too large. In such situations, an entire packet could be received during a period in which the carrier's performance is poor.

Multi-path propagation can give rise to fading dips that are spatially dependent, such that, if a first receiver antenna is located in a fading dip (in which reflected waves add destructively), a high probability exists that a second antenna, located sufficiently distant from the first antenna, is at a position at which reflected waves add constructively rather that destructively. The first and second antennas are said to be uncorrelated. The required distance between the first and second antennas in order for them to be uncorrelated is related to the wavelength of a carrier used and radiation patterns of the antennas.

In addition to being spatially dependent, fading due to propagation is typically also frequency selective. Therefore, if performance of a first carrier having a first frequency is poor, performance of a second carrier having a second frequency is often better, especially if the second frequency is not too close to the first frequency. The coherence bandwidth is a measure of how far apart the two frequencies must be in order for the two carriers to be uncorrelated.

Reference is now made to FIG. 1, wherein there is shown a graph representing an exemplary indoor channel (operating at 2.45 GHz) as a function of frequency. Graph 100 shows frequency in MegaHertz (MHz) on an x-axis and on a y-axis, signal strength is plotted in decibels (dB) (i.e., 20 log [absH(f)]). A bandwidth of a channel 102 is shifted on the x-axis so that 0 Hz corresponds to the carrier being used. The channel 102 has good performance near 0 Hz and 10-15 MHz, whereas it is about 10 dB worse near 23 MHz, and has its worst performance at about 6 MHz. The channel of FIG. 1 has a coherence bandwidth of about 10 MHz.

One way of communicating over a frequency-selective carrier is by means of frequency hopping (FH), which is used, for example, in the BLUETOOTH wireless technology system. See, e.g., J. C. Haartsen, “The Bluetooth radio system,” IEEE Personal Communications, Vol. 7, No. 1, Feb. 2000. In the BLUETOOTH wireless technology system, which is an ad-hoc system that operates in the unlicenced Industrial Scientific and Medical (ISM) band at 2.45 GHz, one of the reasons for employing FH over 79 1-MHz-wide carriers is to avoid transmitting on a single carrier that could be strongly attenuated for a long time period due to multi-path fading. Another reason for using FH is to have a system that is robust to interference from other users as well as from other impairments.

Frequency hopping is a way of averaging quality of the total available bandwidth, and in situations in which the carrier performance changes rapidly, FH often provides best-case real-world performance. However, in situations in which a portion of the bandwidth changes slowly, it would be desirable to further improve performance. For example, if a part of the bandwidth is disturbed by an almost static interferer, this part of the bandwidth should typically be avoided. A static interferer could, for example, be a turned-on microwave oven, since many microwave ovens use part of the ISM band.

Another way to counteract the negative effects of multi-path fading is to employ diversity, such as, for example, antenna diversity. There are a number of different ways diversity can work, such as, for example, those described in Microwave Mobile Communications, W. C. Jakes (ed.), IEEE Press, 1974. In switched diversity, a diversity branch is used so long as its performance is considered good enough. Once the branch's performance is no longer considered to be good enough, a switch is made to another branch. In other types of diversity, such as, for example, equal gain combining, maximum ratio combining, or select largest, all branches are monitored, so that the performance of all of the branches is known. Although monitoring of all branches is desirable from a performance point of view, it is complex and costly. In addition, in some cases is not an option. This can be the case when the diversity branches comprise different carrier frequencies. In such a situation, it might be infeasible to scan the carriers to determine which carrier is the best one to use. Rather, typically a carrier is used until its performance becomes unacceptable, at which time a switch to another carrier occurs.

There is accordingly a need for a method and system for optimization of switched-diversity performance in which a determination is made of when a currently-used branch's performance should be deemed unacceptable and a prediction is made whether a branch's performance will become unacceptable in the near future, including a mechanism that can determine if and when it is a good time to switch to another diversity branch.

### SUMMARY OF THE INVENTION

These and other drawbacks of the prior art are overcome by the present invention, in which a method of optimizing switched diversity comprises determining a rate of change of strength values of a received signal of a first branch (e.g., carrier or antenna) as a function of time, comparing a magnitude of the rate of change to a threshold, and switching to a second branch in response to a determination that the magnitude of the rate of change exceeds the threshold.

Another method in accordance with the present invention of optimizing switch diversity comprises determining a rate of change of strength values of a received signal of a first branch operating at a first modulation scheme as a function of time, comparing a magnitude of the rate of change to a threshold, and switching to a second, more robust, modulation scheme in response to a determination that the magnitude of the rate of change exceeds the threshold.

An apparatus for optimizing switch diversity comprises means for determining a rate of change of strength values of a received signal of a first branch as a function of time, means for comparing a magnitude of the rate of change to a threshold, and means for switching to a second branch in response to a determination that the magnitude of the rate of change exceeds the threshold.

Another method of optimizing switched diversity comprises determining a rate of change of strength values of a received signal of a first branch operating at a first coding scheme as a function of time, comparing a magnitude of the rate of change to a threshold, and switching to a second, more robust, coding scheme in response to a determination that the magnitude of the rate of change exceeds the threshold.

Another apparatus for optimizing switched diversity comprises means for determining a rate of change of strength values of a received signal of a first branch operating at a first modulation scheme as a function of time, means for comparing a magnitude of the rate of change to a threshold, and means for switching to a second, more robust, modulation scheme in response to a determination that the magnitude of the rate of change exceeds the threshold.

Another apparatus for optimizing switched diversity comprises means for determining a rate of change of strength values of a received signal of a first branch as a function of time, means for comparing a magnitude of the rate of change to a threshold, and means for switching to a second branch in response to a determination that the magnitude of the rate of change exceeds the threshold.

Another apparatus for optimizing switched diversity comprises means for determining a rate of change of strength values of a received signal of a first branch operating at a first coding scheme as a function of time, means for comparing a magnitude of the rate of change to a threshold, and means for switching to a second, more robust, coding scheme in response to a determination that the magnitude of the rate of change exceeds the threshold.

### BRIEF DESCRIPTION OF THE DRAWINGS

A more complete understanding of the method and system of the present invention may be acquired by reference to the following Detailed Description when taken in conjunction with the accompanying Drawings wherein:

FIG. 1 is a graph that illustrates an exemplary indoor channel (operating at 2.45 GHz) as a function of frequency;

FIG. 2 is an exemplary graph of received power of a carrier as a function of packet number in accordance with the present invention;

FIG. 3 is an exemplary graph of received power of a carrier as a function of packet number in accordance with the present invention; and

FIG. 4 is a flow diagram of a switch process in accordance with the present invention.

### DETAILED DESCRIPTION

If branch performance changes slowly, it would be desirable to measure quality of an entire available channel bandwidth. Measurement of the entire available bandwidth reveals if there are any parts of the channel that should be avoided because of the presence of static interference and also shows which parts of the channel are performing well and which are performing poorly due to frequency-selective fading. A system that can exploit the latter has been described in the application “Resource management in uncoordinated frequency hopping system,” U.S. patent application Ser. No. 09/385,024, which was filed Aug. 30, 1999 and is incorporated herein by reference. U.S. Provisional Patent Application No. 60/244,766, entitled “Method and Apparatus for Dynamic Carrier Selection” and filed on Oct. 31, 2000, describes, inter alia, creation of a list of candidate carriers from which a best carrier is chosen, and is incorporated by reference.

In application Ser. No. 09/385,024, a high-speed (HS) mode that can be incorporated in, for example, the BLUETOOTH wireless technology system is described. A HS carrier operating according to the HS mode is based on a dynamic carrier selection (DCS) algorithm rather than on frequency hopping (FH). With DCS, carriers in the available bandwidth that are attractive both from a propagation (i.e., fading) and from an interference (i.e., low disturbance) point of view are selected.

In DCS, as in switched antenna diversity, once the performance of the branch becomes unacceptable, a switch to a new branch that is expected to yield better performance occurs. An advantage of DCS is that no extra antenna is needed, whereas an advantage of switched antenna diversity is that it is faster and can be handled by a receiver or by a transmitter. In contrast, DCS requires that both the transmitter and the receiver be invoked.

For switched diversity to work properly, switches between the diversity branches must occur at the proper instants in time. Unnecessary switches should not occur, since an unnecessary switch might result in a switch to a branch that yields worse performance than the branch from which the switch occurred. However, if performance of a currently-used branch starts to deteriorate, it might be advisable to switch to another branch before the performance of the currently-used branch becomes unacceptably poor. It is therefore important that there be a systematic approach to determine when a switch between diversity branches should be performed.

An algorithm for measuring the branches, where in fact the branches are different carriers, and creating a candidate list that can be used in the event that a currently-used carrier's performance becomes bad, is described in Application No. 60/244,766. A determination of when a currently-used branch's performance should be deemed unacceptable and how to predict whether a branch's performance will become unacceptable in the near future, including a mechanism that can be used to determine if and when it is a good time to switch to another diversity branch, will now be described.

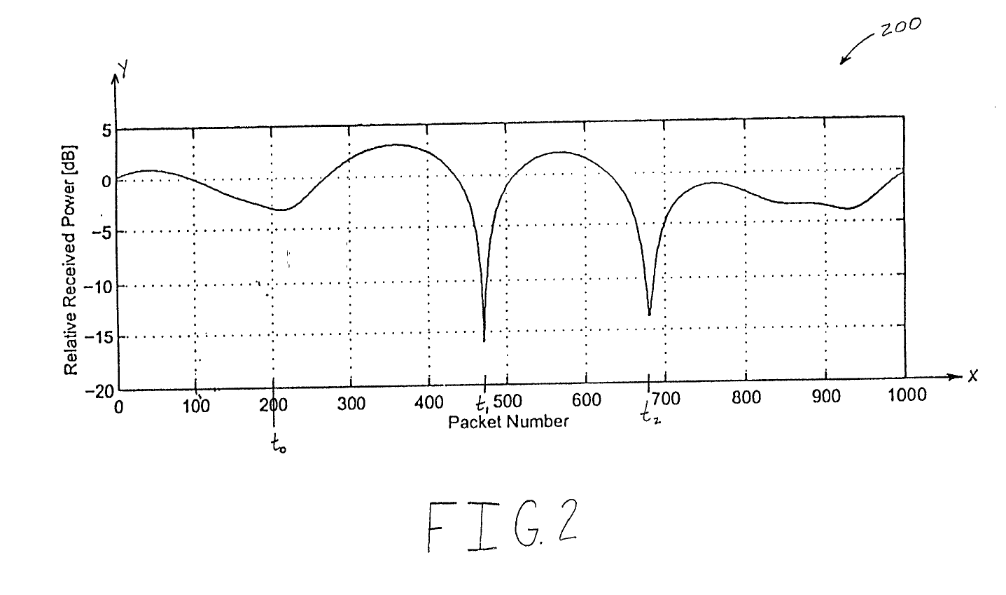

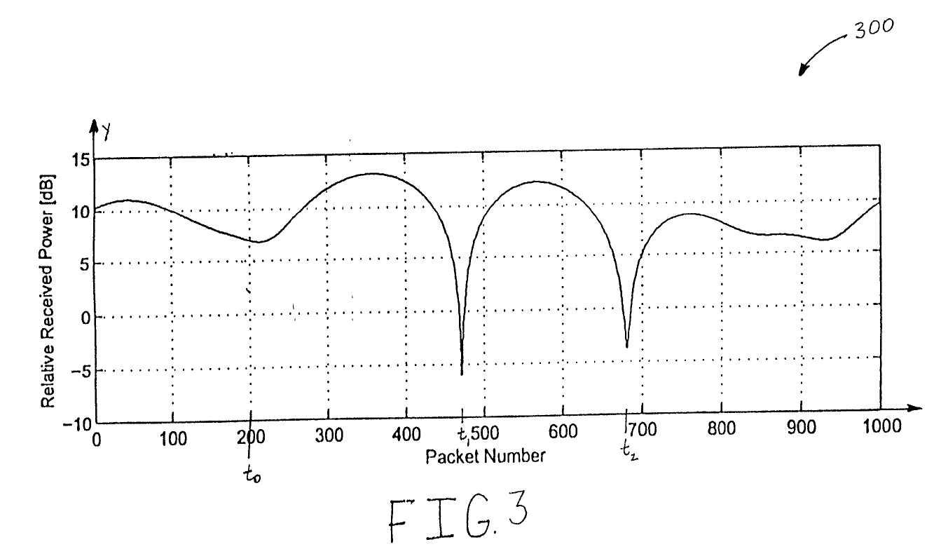

Reference is now made to FIGS. 2 and 3, wherein there are shown exemplary graphs of received power of a branch as a function of packet number in accordance with the present invention. FIG. 2 and FIG. 3 are identical, except that, in FIG. 3, a branch's received signal is 10 dB greater than a branch's received signal in FIG. 2. The x-axes of FIG. 2 and FIG. 3 show a number of packets transmitted on a particular branch (e.g., a carrier operating at 6 MHz) over time. The y-axes of FIGS. 2 and 3 show relative received power in decibels (dB).

FIGS. 2 and 3 each show fading dips between packets 400 and 500 at a time t₁ and between packets 600 and 700 at a time t₂. In FIG. 2, the dip at the time t₁ is to approximately −15 dB, while the corresponding dip of FIG. 3 is to approximately −5 dB. Similarly, the dip at the time t₂ of FIG. 2 is to approximately −13 dB, while the corresponding dip of FIG. 3 is to approximately −3 dB.

One way to determine when a switch to another branch should occur would be to set a threshold and then switch to another diversity branch if this threshold is crossed from above, meaning that the branch's performance is degrading. For example, such a threshold could be placed at 0 dB if it has been determined that a branch's performance is acceptable so long as received power exceeds −3 dB. The threshold would most typically be placed at, for example, 0 dB to provide adequate time for a switch to occur before the branch's performance becomes unacceptable. If only received power is considered in triggering a switch, the threshold would probably yield acceptable, although not optimal, performance.

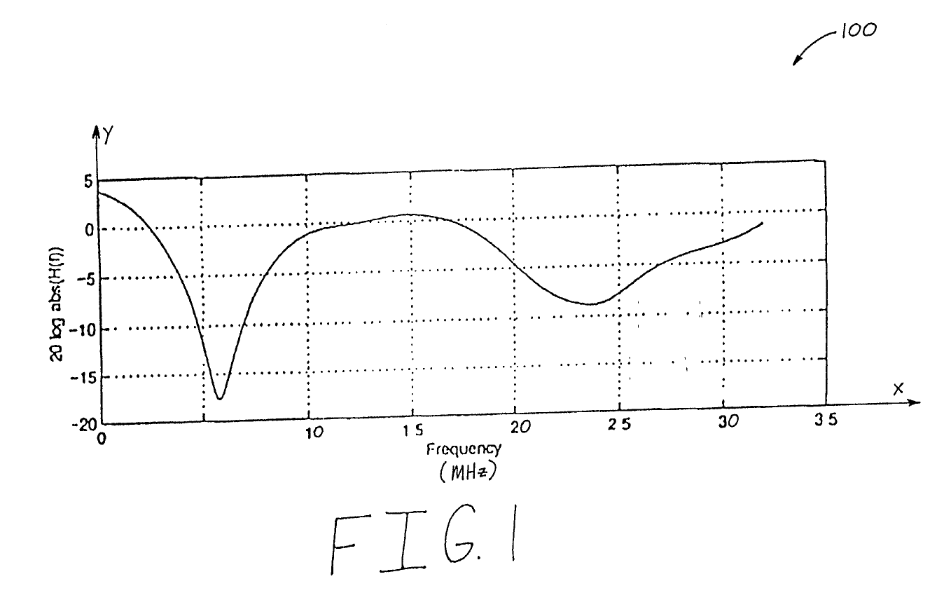

In many situations, the problem is not so much that the received power drops, but rather that when this happens, the branch is frequency-selective. Referring now to FIG. 1, FIG. 2 and FIG. 3, time behavior is depicted in FIG. 2 and FIG. 3 for one particular branch (e.g., a carrier at 6 MHz) of FIG. 1. FIG. 1 shows the absolute value of a transfer function H(f) of the bandwidth in decibels (i.e., 20 log [abs (H(f)]) as a function of frequency.

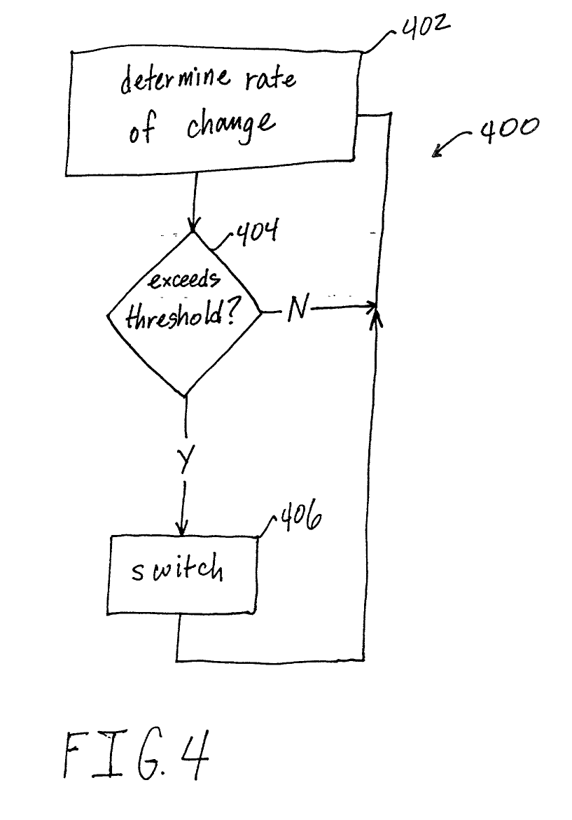

The characteristic feature of a deep multi-path fade is that the absolute value of the branch's time derivative (i.e., the rate at which the branch's received power changes per unit time) is large. Therefore, the absolute value of the branch's time derivative is large at the time t₁ (i.e., approximately packet number 480) and at the time t₂ (i.e., at about packet number 690) for both FIG. 3 and 4. Correspondingly, as shown in the frequency domain by FIG. 1, the absolute value of the frequency derivative of the branch's received power is also large near 6 MHz, where frequency-selective fading is occurring When the time derivative of the branch's received power is relatively small, such as, for example, as shown on FIG. 2 at time t₀ (i.e., at approximately packet number 200), received power of the branch is likely to be near the average (over time) of the received power. If the frequency derivative of the branch's received power is small, as shown, for example, on FIG. 1 at approximately 23 MHz, the branch's received power is likely to be relatively constant.

A problem with frequency-selective branches is that, because different-frequency parts of a received signal are affected to varying degrees by multi-path fading, a received signal comprising different paths is often distorted due to inter-symbol interference (ISI). If the ISI is large enough, there will almost certainly be errors on the branch, even if the received power of the branch is sufficient.

Referring again to FIGS. 2 and 3, if a problem occurs due to high ISI and the received power of the branch is not unacceptably low, a packet received at, for example, less than 5 dB in FIG. 3 would likely be received in error. This is in spite of the fact that the received power of the branch is good and is because the branch is in a fading dip. Alternatively, for FIG. 2, packets might be properly received at a power greater than −5 dB, since as long as the received power is above −5 dB, there are no deep fading dips.

The present invention exploits the fact that a large negative value of the time derivative of a branch's received power typically means that a branch is about to encounter a fading dip. In an embodiment of the present invention, this is done by comparing an RSSI value for a kth packet, RSSI(k), with a previously-received RSSI value. Information from previously-received RSSI values can be included in a value \overline{RSSI}(k), which is defined as:

\overline{RSSI}(k)f[RSSI(k), RSSI(k−1) . . . RSSI(1)] (1)

wherein f is a function that determines how the previous RSSI values should be used.

The function f could, for example, calculate average received power by means of a moving average. For example, \overline{RSSI} at the instant of time when the kth packet arrives could be calculated as

$$\overline{RSSI} ( k ) = \frac{1}{N} {\sum }_{n = k - N}^{k - 1} RSSI ( n ) \qquad ( 2 )$$

where RSSI(n) is the RSSI value for packet number n, and N is the number of packets used to create the average. A rapid change in received power in the time domain can be detected if the RSSI(k) is significantly smaller than \overline{RSSI}(k).

Another choice for f could be a function that estimates the time derivative of the RSSI value. The time derivative could be estimated in several ways. A simple, although not perfectly accurate, way to estimate the derivative can be obtained by (2) if we let N=1. This means that \overline{RSSI}(k)=RSSI(k−1), and thus RSSI(k) is in fact compared to RSSI(k−1). Various switching thresholds to which an estimated time-derivative could be compared could be devised. Different degrees of precision in determining or estimating the time derivative can be employed as needed and are well-known by those skilled in the art.

In another embodiment of the present invention, the threshold used for switched diversity is a function of modulation and coding, such as, for example, when adaptive modulation is employed and transmission by means of M-ary phase shift keying (PSK) is used in which M=2, 4, or 8. If the branch's performance is good, 8-PSK would be used; if the branch's performance becomes worse, a change to 4-PSK would be made. If the branch's performance becomes even worse, 2-PSK would be used.

Referring again to FIGS. 2 and 3, 8-PSK can be used as long as the branch's performance is above a certain level relative to its average. 4-PSK modulation will work at worse branch performance conditions than 8-PSK; therefore, a switch does not need to occur as early if 4-PSK is used as if 8-PSK were used. In other words, 4-PSK permits a lower branch-performance threshold than does 8-PSK. If 2-PSK is employed, a switch can be delayed even more than when 4-PSK or 8-PSK is used and perhaps might not even be necessary, such as, for example, when a fading dip is not deep enough to cause a switch. Thus, where a threshold for performing a switch is set preferably depends on the modulation format used. If adaptive coding were employed, uncoded transmissions would be used when the branch is good and more powerful coding invoked as branch performance worsens. Similarly, when adaptive coding is used, the threshold should be a function also of the coding used.

In yet another embodiment of the present invention, switched diversity is used in combination with adaptive modulation. This means that as the branch performance gets worse, more robust modulation, rather than switching to another diversity branch, is employed. If the branch becomes even worse and the more robust modulation has already been employed, then a switch to another diversity branch based on a threshold corresponding to a currently-employed modulation could be made. Instead of adapting the modulation all the way, for example, from 8-PSK to 2-PSK, a switch between branches could be made as soon as 8-PSK can no longer be used. This effectively means that 4-PSK would be used as a buffer zone to prepare for the switch, if required.

For example, when dynamic carrier selection is used, all parties can be informed that a change of carrier will occur by using 4-PSK, so that a controlled switch can be performed. This would preferably imply that a switch has been made to a new carrier on which 8-PSK can be used before the old carrier has become so bad that a switch would be required to 2-PSK to get information through.

FIG. 4 is a flow diagram of a switch process 400 in accordance with the present invention. The switch process 400 begins at a step 402, wherein a determination is made of the magnitude of the rate of change of the strength values of a received signal of a first branch as a function of time. From step 402, execution proceeds to step 404. At step 404, the magnitude of the rate of change is compared to a pre-defined threshold. If it is determined at step 404 that the rate-of-change magnitude exceeds the threshold, execution proceeds to step 406. If it is not determined at step 404 that the rate-of-change magnitude exceeds the threshold, execution moves to step 402. At step 406, a switch to a second branch is made. From step 406, execution moves to step 402.

The determination of the magnitude of the rate of change of the strength values of the received signal, the comparison of the rate of change to the threshold, switching to a more robust modulation and/or coding scheme, and switching to a second branch would each typically be performed by a combination of hardware (e.g., electronics) and software. This combination of software and hardware would typically be located in a mobile station, such as, for example, a mobile telephone, a BLUETOOTH-compatible device, or the like.

It should be understood that the terms “comprises” and “comprising,” when used in this specification, are taken to specify the presence of stated features, integers, steps, or components, but do not preclude the presence or addition of one or more other features, integers, steps, components or groups thereof.

Although preferred embodiments of the method and system of the present invention have been illustrated in the accompanying FIGURES and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A method of optimizing switched diversity comprising:
determining a rate of change of strength values of a received signal of a first branch as a function of time;
comparing a magnitude of the rate of change to a threshold; and
switching to a second branch in response to a determination that the magnitude of the rate of change exceeds the threshold.

2. The method of claim 1 wherein each branch comprises a carrier.

3. The method of claim 1 wherein each branch comprises an antenna.

4. The method of claim 2 wherein the step of determining comprises using a received-signal-strength indicator (RSSI).

5. The method of claim 4 wherein the step of determining comprises comparing a current-packet RSSI to an RSSI of an earlier-received packet.

6. The method of claim 4 wherein the step of determining comprises estimating a time derivative of the RSSI by calculating an RSSI moving average.

7. The method of claim 2 wherein the threshold is a function of modulation and coding.

8. The method of claim 3 wherein the step of determining comprises using a received-signal-strength indicator (RSSI).

9. The method of claim 8 wherein the step of determining comprises comparing a current-packet RSSI to an RSSI of an earlier-received packet.

10. The method of claim 8 wherein the step of determining comprises estimating a time derivative of the RSSI by calculating an RSSI moving average.

11. The method of claim 3 wherein the threshold is a function of modulation and coding.

12. A method of optimizing switched diversity comprising:
determining a rate of change of strength values of a received signal of a first branch operating at a first modulation scheme as a function of time;
comparing a magnitude of the rate of change to a threshold; and
switching to a second, more robust, modulation scheme in response to a determination that the magnitude of the rate of change exceeds the threshold.

13. The method of claim 12 wherein each branch comprises a carrier.

14. The method of claim 12 wherein each branch comprises an antenna.

15. The method of claim 13 wherein the step of determining comprises using a received-signal-strength indicator (RSSI).

16. The method of claim 15 wherein the step of determining comprises estimating a time derivative of the RSSI by calculating an RSSI moving average.

17. The method of claim 13 wherein the step of determining comprises comparing a current-packet RSSI to an RSSI of an earlier-received packet.

18. The method of claim 13 wherein the threshold is a function of modulation and coding.

19. The method of claim 14 wherein the step of determining comprises using a received-signal-strength indicator (RSSI).

20. The method of claim 19 wherein the step of determining comprises estimating a time derivative of the RSSI by calculating an RSSI moving average.

21. The method of claim 14 wherein the step of determining comprises comparing a current-packet RSSI to an RSSI of an earlier-received packet.

22. The method of claim 14 wherein the threshold is a function of modulation and coding.

23. An apparatus for optimizing switched diversity comprising:
means for determining a rate of change of strength values of a received signal of a first branch as a function of time;
means for comparing a magnitude of the rate of change to a threshold; and
means for switching to a second branch in response to a determination that the magnitude of the rate of change exceeds the threshold.

24. The apparatus of claim 23 wherein each branch comprises an antenna.

25. The apparatus of claim 23 wherein each branch comprises a carrier.

26. The apparatus of claim 24 wherein the means for determining comprises use of a received-signal-strength indicator (RSSI).

27. The apparatus of claim 26 wherein the means for determining comprises comparison of a current-packet RSSI to an RSSI of an earlier-received packet.

28. The apparatus of claim 26 wherein the means for determining comprises estimation of a time derivative of the RSSI by calculating an RSSI moving average.

29. The apparatus of claim 24 wherein the threshold is a function of modulation and coding.

30. The apparatus of claim 25 wherein the means for determining comprises use of a received-signal-strength indicator (RSSI).

31. The apparatus of claim 30 wherein the means for determining comprises comparison of a current-packet RSSI to an RSSI of an earlier-received packet.

32. The apparatus of claim 30 wherein the means for determining comprises estimation of a tim e derivative of the RSSI by calculating an RSSI moving a verage.

33. The apparatus of claim 25 wherein the threshold is a function of modulation and coding.

34. A method of optimizing switched diversity comprising:
determining a rate of change of strength values of a received signal of a first branch operating at a first coding scheme as a function of time;
comparing a magnitude of the rate of change to a threshold; and
switching to a second, more robust, coding scheme in response to a determination that the magnitude of the rate of change exceeds the threshold.

35. The method of claim 34 wherein each branch comprises a carrier.

36. The method of claim 34 wherein each branch comprises an antenna.

37. The method of claim 35 wherein the step of determining comprises using a received-signal-strength indicator (RSSI).

38. The method of claim 37 wherein the step of determining comprises estimating a time derivative of the RSSI by calculating an RSSI moving average.

39. The method of claim 38 wherein the step of determining comprises comparing a current-packet RSSI to an RSSI of an earlier-received packet.

40. The method of claim 35 wherein the threshold is a function of modulation and coding.

41. The method of claim 36 wherein the step of determining comprises using a received-signal-strength indicator (RSSI).

42. The method of claim 41 wherein the step of determining comprises estimating a time derivative of the RSSI by calculating an RSSI moving average.

43. The method of claim 36 wherein the step of determining comprises comparing a current-packet RSSI to an RSSI of an earlier-received packet.

44. The method of claim 36 wherein the threshold is a function of modulation and coding.

45. An apparatus for optimizing switched diversity comprising:
means for determining a rate of change of strength values of a received signal of a first branch operating at a first modulation scheme as a function of time;
means for comparing a magnitude of the rate of change to a threshold; and
means for switching to a second, more robust, modulation scheme in response to a determination that the magnitude of the rate of change exceeds the threshold.

46. The apparatus of claim 45 wherein each branch comprises a carrier.

47. The apparatus of claim 45 wherein each branch comprises an antenna.

48. The apparatus of claim 46 wherein the means for determining uses a received-signal-strength indicator (RS SI).

49. The apparatus of claim 48 wherein the means for determining estimates a time derivative of the RSSI by calculating an RSSI moving average.

50. The apparatus of claim 46 wherein the means for determining compares a current-packet RSSI to an RSSI of an earlier-received packet.

51. The apparatus of claim 46 wherein the threshold is a function of modulation and coding.

52. The apparatus of claim 47 wherein the means for determining uses a received-signal-strength indicator (RSSI).

53. The apparatus of claim 52 wherein the means for determining estimates a time derivative of the RSSI by calculating an RSSI moving average.

54. The apparatus of claim 47 wherein the means for determining compares a current-packet RSSI to an RSSI of an earlier-received packet.

55. The apparatus of claim 47 wherein the threshold is a function of modulation and coding.

56. An apparatus for optimizing switched diversity comprising:
means for determining a rate of change of strength values of a received signal of a first branch operating at a first coding scheme as a function of time;
means for comparing a magnitude of the rate of change to a threshold; and
means for switching to a second, more robust, coding scheme in response to a determination that the magnitude of the rate of change exceeds the threshold.

57. The apparatus of claim 56 wherein each branch comprises a carrier.

58. The apparatus of claim 56 wherein each branch comprises an antenna.

59. The apparatus of claim 57 wherein the means for determining uses a received-signal-strength indicator (RSSI).

60. The apparatus of claim 59 wherein the means for determining estimates a time derivative of the RSSI by calculating an RSSI moving average.

61. The apparatus of claim 57 wherein the means for determining compares a current-packet RSSI to an RSSI of an earlier-received packet.

62. The apparatus of claim 57 wherein the threshold is a function of modulation and coding.

63. The apparatus of claim 58 wherein the means for determining uses a received-signal-strength indicator (RSSI).

64. The apparatus of claim 63 wherein the means for determining estimates a time derivative of the RSSI by calculating an RSSI moving average.

65. The apparatus of claim 58 wherein the means for determining compares a current-packet RSSI to an RSSI of an earlier-received packet.

66. The apparatus of claim 58 wherein the threshold is a function of modulation and coding.
